(19) United States
(12) Patent Application Publication
(10) Pub. No.: US 2009/0128344 A1
(43) Pub. Date: May 21, 2009

(54) Systems, Apparatuses And Methods For Monitoring Physical Conditions Of A Bed Occupant

(75) Inventors: Senthilnathan Sundaram, Vernon Hills, IL (US); Tushad Driver, Streamwood, IL (US); Fawad Ahmad, Schaumburg, IL (US); Weidong Zhao, Gurnee, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/943,841

(22) Filed: Nov. 21, 2007

(51) Int. Cl. G08B 23/00

(52) U.S. Cl. 340/573.1

(57) ABSTRACT

Embodiments of the presently described technology provide apparatuses, systems and methods for monitoring physical conditions of a bed occupant.

### BACKGROUND OF THE INVENTION

Generally, the technical field involves systems, apparatuses and methods for monitoring physical conditions of a bed occupant. Specifically, it involves systems, apparatuses and methods for monitoring the temperature and/or carbon dioxide respiration level of a bed occupant.

There are a number of individuals who require close monitoring and attention such as infants, children, elderly, disabled and physically or mentally ill individuals. Typically a caregiver attempts to closely watch the individual's physical conditions in order to become aware of potential problems and respond appropriately. The caregiver's duties typically extend into evening hours when the caregiver is also trying to obtain needed rest.

For example, infants need particularly close monitoring. Typically, a parent closely monitors his or her infant to detect any problems and respond accordingly. A parent tries to closely watch and listen to the infant to detect signs of distress. Closely monitoring an infant during sleep is also important since an infant can enter a dangerous physical condition during sleep. However, monitoring during the infant's sleep can be particularly difficult since the parent may also be attempting to sleep or complete other household tasks that are difficult to complete when the infant is awake.

Monitoring of an infant can become particularly difficult when the infant is ill. For example, a parent may need to monitor an infant with a fever more closely than usual. The parent may need to regularly check the infant's temperature to male sure it doesn't reach a dangerously high level. This can be particularly difficult at night when it may require waking the infant frequently to check his or her temperature.

Another reason for closely monitoring infants is to prevent sudden infant death syndrome (SIDS). SIDS or “crib death” is the leading cause of death among infants who are 1 month to 1 year old. SIDS claims the lives of about 2,500 infants each year in the United States alone. Very little is known about the possible causes of SIDS and little is known about its prevention. One theory is that the infants turn during sleep and inhale the carbon dioxide that they have previously exhaled. When this “rebreathing” occurs for a prolonged time the infant can suffocate and die.

### BRIEF SUMMARY OF THE INVENTION

Certain embodiments of the presently described technology provide systems, apparatuses and methods for monitoring physical conditions of a bed occupant. Specifically, it involves systems, apparatuses and methods for monitoring the temperature and/or carbon dioxide respiration level of a bed occupant.

Certain embodiments of the presently described system for monitoring physical conditions of a bed occupant comprise bedding with sensors embedded within said bedding, wherein said sensors detect parameters dealing with a bed occupant's physical condition; a receiver, wherein said receiver monitors said detected parameters from said sensors for a presence of alert events related to the bed occupant's physical condition; a transmitter, wherein said transmitter receives said presence of alert events from said receiver and transmits said presence of alert events; and an alerting device, wherein said alerting device receives said presence of alert events and alerts a caregiver of said presence of alert events.

Certain embodiments of the presently described system for monitoring physical conditions of a bed occupant comprise bedding with sensors embedded within said bedding, wherein said sensors detect parameters dealing with a bed occupant's physical condition; a receiver, wherein said receiver monitors said detected parameters from said sensors and obtains specified parameter values at specified intervals from said sensors; a transmitter, wherein said transmitter receives said specified parameter values from said receiver and transmits said specified parameter values; and an alerting device, wherein said alerting device receives said specified parameter values from said transmitter and alerts a caregiver of said specified parameter values at said specified intervals.

Certain embodiments of the presently described method of monitoring physical conditions of a bed occupant comprise detecting parameters dealing with a bed occupant's physical condition using sensors embedded in bedding; monitoring said detected parameters for a presence of alert events in said detected parameters based on the bed occupant's physical condition; transmitting said presence of alert events to an alerting device; and alerting a caregiver of said presence of alert events using said alerting device.

Certain embodiments of the presently described method of monitoring physical conditions of a bed occupant comprise detecting parameters dealing with a bed occupant's physical condition using sensors embedded in bedding; monitoring said detected parameters to obtain specified parameter values at specified intervals based on said bed occupant's physical condition; transmitting said specified parameter values to an alerting device; and alerting a caregiver of said specified parameter values at said specified intervals using said alerting device.

These and other features of the presently described invention are discussed or apparent in the following detailed description.

### BRIEF DESCRIPTION OF SEVERAL VIEWS OF THE DRAWINGS

FIG. 1 illustrates an apparatus for monitoring physical conditions of a bed occupant according to an embodiment of the presently described technology.

FIG. 2 illustrates a system for monitoring physical conditions of a bed occupant according to an embodiment of the presently described technology.

FIG. 3 illustrates a flow diagram for a method of monitoring physical conditions of a bed occupant according to an embodiment of the presently described technology.

FIG. 4 illustrates a flow diagram for a method of monitoring physical conditions of a bed occupant according to an embodiment of the presently described technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The presently described technology relates to systems, apparatuses and methods for monitoring physical conditions of a bed occupant. Specifically, it involves systems, apparatuses and methods for monitoring the temperature and/or carbon dioxide respiration level of a bed occupant. Although certain particulars are used as examples, the presently described technology should not be viewed as limited to such systems, apparatuses or methods.

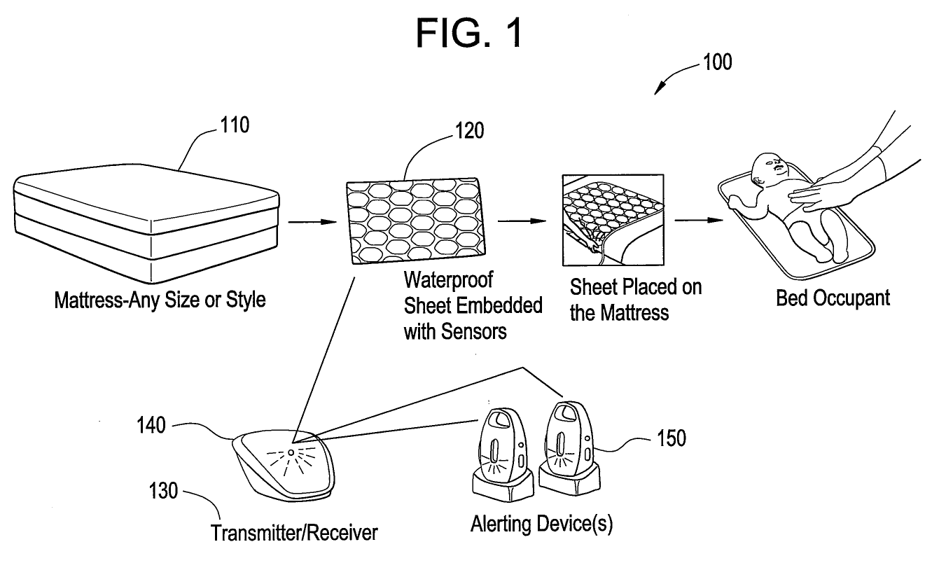

FIG. 1 illustrates an apparatus (100) for monitoring physical conditions of a bed occupant according to an embodiment of the presently described technology. In one embodiment, the apparatus (100) comprises bedding (110), sensors (120) embedded in the bedding, a receiver (130), a transmitter (140) and an alerting device (150).

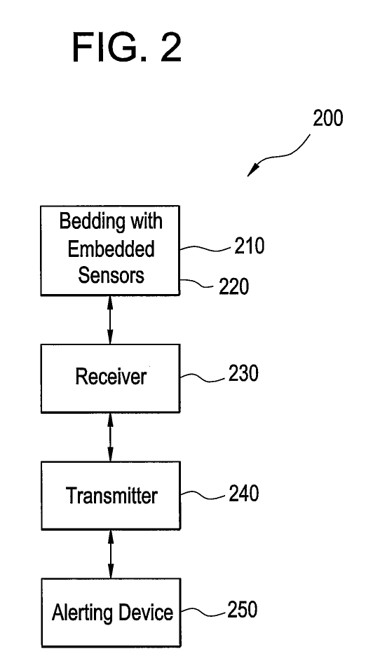

FIG. 2 illustrates a system (200) for monitoring physical conditions of a bed occupant according to an embodiment of the presently described technology. In one embodiment, the system (200) comprises bedding (210) with embedded sensors (220), a receiver (230), a transmitter (240) and an alerting device (250). The embedded sensors (220) are in communication with the receiver (230). The receiver (230) is in communication with the transmitter (240). The transmitter (240) is in communication with the alerting device (250).

The components of the system (200) may be implemented alone or in combination in hardware, firmware, and/or as a set of instructions in software, for example. Certain embodiments may be provided at least in part as a set of instructions residing on a computer-readable medium, such as a memory, hard disk, DVD, or CD, for execution on a general purpose computer or other processing device. Certain components may be integrated in various forms and/or may be provided at least in part as software and/or other functionality on a computing device, such as a computer. Certain embodiments may omit one or more of the components of the system (200).

The system (200) is comprised of bedding (210) with embedded sensors (220). The bedding (210) can be a portion of the bed itself or a covering on the bed. Non-limiting examples of bedding (210) include mattresses, mattress pads, mattress sheets, blankets, pillows, and pillow cases. In one embodiment, the bedding (210) is a mattress sheet. In another embodiment, the bedding (210) is a mattress sheet for a crib.

Bedding is likely to come into contact with bodily fluids such as urine, saliva, feces and blood. This is particularly true with infants, children, elderly, disabled and physically or mentally ill individuals. In one embodiment the bedding (210) can be waterproof. For example the bedding can be made of a material that can easily be cleaned with a wet wash cloth. In another example, the bedding can be made of a material that can be submerged in water. In another embodiment the bedding (210) can be machine washable. In an embodiment with waterproof and/or washable bedding electronic components could be removable.

The bedding (210) has sensors (220) embedded in it. The sensors (220) can be located in a number of different places on the bedding (210). For example, the sensors (220) could be inside of the bedding (210), on top of the bedding (210), under the bedding (210). The sensors (220) can be arranged in a number of different configurations. For example the sensors could be randomly arranged. The sensors (220) could also be arranged in a specialized pattern, such as diamonds, squares or lines. The sensors (220) could be completely located or more heavily located in one area of the bedding. For example, a larger number or all of the sensors (220) could be located near where a certain part of the bed occupant's body would rest, such as the head or chest.

The sensors (220) could be any type of sensor (220) known by those knowledgeable in the technology. For example, the sensors (220) could be diaphragms or thermocouples. In one example, the sensors (220) are crosswire type sensors. The sensors (220) can detect a number of different parameters dealing with a bed occupant's physical condition. For example, the sensors (220) can detect the bed occupant's temperature or the carbon dioxide level in the bed occupant's respiration. There can be multiple types of sensors (220) in one piece of bedding (210). In one example, the sensors (220) detect temperature of the bed occupant. In another example, the sensors (220) detect carbon dioxide level in the bed occupant's respiration. In yet another example, both temperature and carbon dioxide level sensors (220) are present in the bedding (210).

In one embodiment the sensors (220) are powered by a battery pack. The battery pack can be removable. As discussed above, this is particularly useful in the waterproof and/or washable embodiment.

The sensors are in communication with a receiver (230). The receiver (230) could be any type of receiver (230) known by those knowledgeable in the technology. For example, the receiver (230) could be an electromagnetic pulse or wave receiver. The sensors (220) communicate the detected parameters to the receiver (230). The receiver (230) receives these detected parameters from the sensors (240). The receiver (230) monitors the detected parameters.

In a first embodiment, the receiver (230) monitors the detected parameters for the presence of an alert event. An alert event could be a level which a certain parameter should not fall below or rise above. For example, an alert event could be a temperature indicative of a fever in the bed occupant. When the temperature of the bed occupant rises to a temperature indicative of a fever, the receiver (230) registers the presence of an alert event. In another example, the alert event could be a carbon dioxide level in the bed occupant's respiration that is indicative of a problem with the bed occupant (such as SIDS in an infant). When the carbon dioxide level in the bed occupant's respiration reaches such a level the receiver (230) registers the presence of an alert event. The alert events could be pre-programmed values and/or could be user programmable.

In a second embodiment, the receiver (230) monitors the parameters to obtain readings for a specified parameter after the passage of a specified time interval. In this embodiment, the receiver (230) registers a specified parameter value at specified intervals. For example, the receiver (230) could register a bed occupant's temperature every hour or it could register the carbon dioxide level in the bed occupant's respiration every five minutes. The parameter to register and the interval could be pre-programmed and/or could be user programmable, for example.

For both the first and second embodiments, the receiver (230) is in communication with a transmitter (240). The transmitter (240) could be any type of transmitter (240) known by those knowledgeable in the technology. For example, the transmitter (240) could be a wireless transmitter. The receiver (230) communicates the presence of an alert event and/or specified parameter value to the transmitter. The transmitter (240) receives the notice of the presence of an alert events and/or specified parameter values from the receiver (230). The transmitter (240) and the receiver (230) can be combined or separate.

For both the first and second embodiments, the transmitter (240) is in communication with an alerting device (250). The alerting device (250) could be any type of alerting device (250) known by those knowledgeable in the technology. The alerting device (250) could be a handheld device or table top device that can be kept in proximity to the caregiver. The transmitter (240) communicates the presence of an alert event and/or specified parameter value to the alerting device (250). In the first embodiment upon receiving the notice of the presence of an alert event the alerting device (250) could vibrate, create an audible alarm, create a visual alarm, or some combination thereof. In the second embodiment upon receiving the specified parameter value the alerting device could display the specified parameter value along with vibrating, creating an audible alarm, creating a visual alarm, or some combination thereof. In both embodiments, the alerting device could additionally or alternatively generate a log, generate a record, e-mail an alert message and/or fax an alert message.

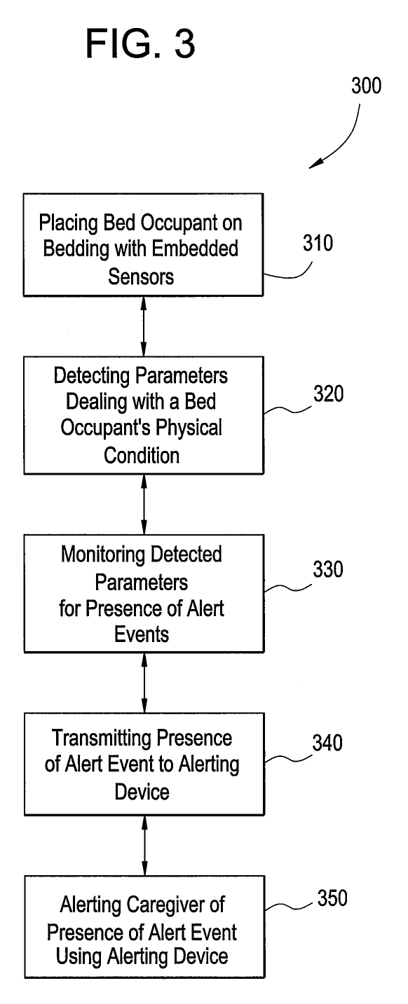

FIG. 3 illustrates a method (300) of monitoring physical conditions of a bed occupant according to an embodiment of the presently described technology. The method (300) involves placing a bed occupant on bedding with embedded sensors (310); detecting parameters dealing with a bed occupant's physical condition using the sensors embedded in bedding (320); monitoring the detected parameters for a presence of alert events in the parameters (330); transmitting the presence of alert events to an alerting device (340); and alerting a caregiver of the presence of alert events using the alerting device (350).

In the first step and second steps, a bed occupant is placed on bedding with embedded sensors (310) and parameters dealing with a bed occupant's physical condition are detected using sensors embedded in bedding (320). The sensors embedded in bedding may take the form of bedding with embedded sensors, such as bedding (210) and sensors (220) discussed above. The bedding can be a portion of the bed itself or a covering on the bed. Non-limiting examples of bedding include mattresses, mattress pads, sheets, blankets, pillows, and pillow cases. In one embodiment, the bedding is a sheet. In another embodiment, the bedding is a sheet for a crib and the bed occupant is an infant. As discussed above, the bedding can be waterproof and/or washable. The electronic components can also be removable to facilitate cleaning.

The sensors can be located in a number of different places on the bedding, such as inside the bedding, on top of the bedding and/or under the bedding. The sensors can be arranged in a number of different configurations. They could be randomly arranged and/or in a specialized pattern, such as diamonds, squares or lines. As discussed above, the sensors could be completely located or more heavily located in one area of the bedding. For example, carbon dioxide level sensors could be located near the area where the head of the bed occupant would be positioned.

The sensors could be any type of sensor known by those knowledgeable in the technology, such as crosswire type sensors, diaphragms or thermocouples. The sensors can detect a number of different parameters dealing with a bed occupant's physical conditions, such as the bed occupant's temperature or carbon dioxide level in the bed occupant's respiration. As discussed above, there can be multiple types of sensors in one piece of bedding.

In the third step, the detected parameters are monitored for the presence of an alert event in the detected parameters (330). The monitoring may be carried out using a receiver, such as receiver (230) discussed above. The receiver could be any type of receiver known by those knowledgeable in the technology, such as an electromagnetic pulse or wave receiver. The sensors communicate the detected parameters to the receiver. The receiver receives these detected parameters from the sensors. The receiver monitors the detected parameters for the presence of an alert event.

As discussed above, an alert event could be a level which a certain parameter should not fall below or rise above. For example, an alert event could be a temperature indicative of a fever in the bed occupant. In another example, the alert event could be a carbon dioxide level in the bed occupant's respiration that is indicative of a problem with the bed occupant (such as SIDS in an infant). The alert events could be pre-programmed values and/or could be user programmable, for example.

In the fourth step, the presence of alert events is transmitted to an alerting device (340). The transmitting may be carried out using a transmitter, such as transmitter (240) discussed above. The transmitter could be any type of transmitter known by those knowledgeable in the technology, such as a wireless transmitter. The receiver communicates the presence of an alert event to the transmitter. The transmitter receives notification of the presence of the alert event and transmits that notice on to an alerting device.

The fifth step is alerting a caregiver of the presence of alert events using the alerting device (350). The alerting device may be an alerting device, such as alerting device (250) discussed above. The alerting device could be any type of alerting device known by those knowledgeable in the technology, such as a handheld device or table top device that can be kept in proximity to the caregiver. The transmitter communicates the presence of an alert event to the alerting device. Upon receiving notice of the presence of an alert event the alerting device could vibrate, create an audible alarm, create a visual alarm, or some combination thereof. The alerting device could additionally or alternatively generate a log, generate a record, e-mail an alert message and/or fax an alert message.

One or more of the steps of the method (300) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (300) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

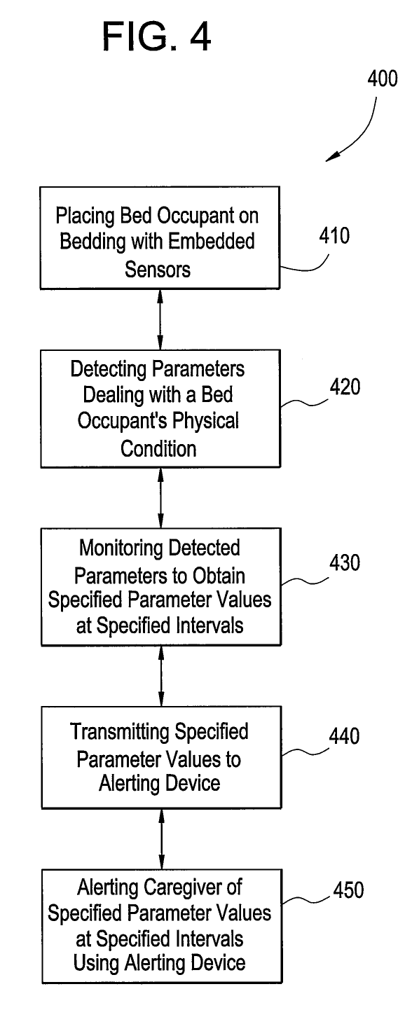

FIG. 4 illustrates a method (400) of monitoring physical conditions of a bed occupant according to an embodiment of the presently described technology. The method (400) involves placing a bed occupant in on bedding with embedded sensors (410); detecting parameters dealing with a bed occupant's physical condition using the sensors embedded in bedding (420); monitoring the detected parameters to obtain specified parameter values at specified intervals (430); transmitting the specified parameter values to an alerting device (440); and alerting a caregiver of the specified parameter values (450).

In the first step and second steps, a bed occupant is placed on bedding with embedded sensors (410) and parameters dealing with a bed occupant's physical condition are detected using sensors embedded in bedding (420). The sensors embedded in bedding may take the form of bedding with embedded sensors, such as bedding (210) and sensors (220) discussed above. The bedding can be a portion of the bed itself or a covering on the bed. Non-limiting examples of bedding include mattresses, mattress pads, sheets, blankets, pillows, and pillow cases. In one embodiment, the bedding is a sheet. In another embodiment, the bedding is a sheet for a crib and the bed occupant is an infant. As discussed above, the bedding can be waterproof and/or washable. The electronic components can also be removable to facilitate cleaning.

The sensors can be located in a number of different places on the bedding, such as inside the bedding, on top of the bedding and/or under the bedding. The sensors can be arranged in a number of different configurations. They could be randomly arranged and/or in a specialized pattern, such as diamonds, squares or lines. As discussed above, the sensors could be completely located or more heavily located in one area of the bedding. For example, carbon dioxide level sensors could be located near the area where the head of the bed occupant would be positioned.

The sensors could be any type of sensor known by those knowledgeable in the technology, such as crosswire type sensors, diaphragms or thermocouples. The sensors can detect a number of different parameters dealing with a bed occupant's physical conditions, such as the bed occupant's temperature or carbon dioxide level in the bed occupant's respiration. As discussed above, there can be multiple types of sensors in one piece of bedding.

In the third step, detected parameters are monitored to obtain specified parameter values at specified intervals (430). The monitoring may be carried out using a receiver, such as receiver (230) discussed above. The receiver could be any type of receiver known by those knowledgeable in the technology, such as an electromagnetic pulse or wave receiver. The sensors communicate the detected parameters to the receiver. The receiver receives these detected parameters from the sensors. The receiver monitors the detected parameters for the specified parameter values at specified intervals.

As discussed above, the receiver monitors the parameters to obtain readings for a specified parameter after the passage of a specified time interval. The receiver registers a specified parameter value at specified intervals. For example, the receiver could register a bed occupant's temperature or carbon dioxide level in the bed occupant's respiration every hour. The parameter to register and the interval could be pre-programmed and/or could be user programmable.

In the fourth step, the specified parameter value at a specified interval is transmitted to an alerting device (440). The transmitting may be carried out using a transmitter, such as transmitter (240) discussed above. The transmitter could be any type of transmitter known by those knowledgeable in the technology, such as a wireless transmitter. The receiver communicates the specified parameter value at a specified interval to the transmitter. The transmitter receives the specified parameter value at a specified interval and transmits that specified parameter value at a specified interval on to an alerting device.

The fifth step is alerting a caregiver of the specified parameter value at a specified interval using the alerting device (450). The alerting device may be an alerting device, such as alerting device (250) discussed above. The alerting device could be any type of alerting device known by those knowledgeable in the technology, such as a handheld device or table top device that can be kept in proximity to the caregiver. The transmitter communicates the specified parameter value at a specified interval to the alerting device. Upon receiving notice of the specified parameter value at a specified interval the alerting device could display the specified parameter value. The alerting device could additionally vibrate, create an audible alarm, create a visual alarm, or some combination thereof. The alerting device could additionally or alternatively generate a log, generate a record, e-mail an alert message and/or fax an alert message.

One or more of the steps of the method (400) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (400) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In one example, a re-usable, waterproof, washable mattress sheet for a crib has embedded temperature and carbon-dioxide sensors, a removable battery pack, a programmable transmitter/receiver and a hand-held alerting device. An infant is placed on the mattress sheet. If the infant's body temperature or the carbon dioxide level in its respiration exceeds preset limits. The transmitter/receiver sends a message to the alerting device. The alerting device could vibrate, light up and sound an audible alarm alerting a caregiver to the infant's problem.

In another embodiment, a mattress has embedded temperature and carbon-dioxide sensors, a removable battery pack, a programmable transmitter/receiver and a hand-held alerting device. An individual is placed on the mattress sheet. The sensors detect the individual's temperature and carbon dioxide level in his or her respiration. The transmitter/receiver obtains and transmits these values for a preset interval, 1 hour in this example. The transmitter/receiver sends a message to the alerting device. The alerting device displays the values for the individual's temperature and carbon dioxide level in his or her respiration after each interval.

Thus, certain embodiments provide the technical effect of monitoring physical conditions of a bed occupant. Specifically, certain embodiments provide the technical effect of monitoring the temperature and/or carbon dioxide respiration level of a bed occupant.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

1. A system for monitoring physical conditions of a bed occupant comprising:
bedding with sensors embedded within said bedding, wherein said sensors detect parameters dealing with a bed occupant's physical condition;
a receiver, wherein said receiver monitors said detected parameters from said sensors for a presence of alert events related to the bed occupant's physical condition;
a transmitter, wherein said transmitter receives said presence of alert events from said receiver and transmits said presence of alert events; and
an alerting device, wherein said alerting device receives said presence of alert events and alerts a caregiver of said presence of alert events.

2. The system of claim 1 wherein said detected parameter is carbon dioxide level in the bed occupant's respiration.

3. The system of claim 1 wherein the bedding is a mattress sheet.

4. The system of claim 1 wherein the bedding is washable.

5. The system of claim 1 wherein said sensors are operated by a removable battery pack.

6. The system of claim 1 wherein said alert events are user programmable.

7. The system of claim 1 wherein the bedding is for a crib.

8. A system for monitoring physical conditions of a bed occupant comprising:
bedding with sensors embedded within said bedding, wherein said sensors detect parameters dealing with a bed occupant's physical condition;
a receiver, wherein said receiver monitors said detected parameters from said sensors and obtains specified parameter values at specified intervals from said sensors;
a transmitter, wherein said transmitter receives said specified parameter values from said receiver and transmits said specified parameter values; and
an alerting device, wherein said alerting device receives said specified parameter values from said transmitter and alerts a caregiver of said specified parameter values at said specified intervals.

9. The system of claim 8 wherein said detected parameter is the bed occupant's temperature.

10. The system of claim 8 wherein the bedding is a mattress sheet.

11. The system of claim 8 wherein the bedding is waterproof.

12. The system of claim 8 wherein said sensors are operated by a removable battery pack.

13. The system of claim 8 wherein said alert events are user programmable.

14. The system of claim 8 wherein the bedding is for a crib.

15. A method of monitoring physical conditions of a bed occupant comprising:
detecting parameters dealing with a bed occupant's physical condition using sensors embedded in bedding;
monitoring said detected parameters for a presence of alert events in said detected parameters based on the bed occupant's physical condition;
transmitting said presence of alert events to an alerting device; and
alerting a caregiver of said presence of alert events using said alerting device.

16. The method of claim 15 wherein the detected parameter is carbon dioxide level in the bed occupant's respiration.

17. The method of claim 15 wherein the bedding is for a crib.

18. The method of claim 15 wherein the bedding is a mattress sheet.

19. The method of claim 15 wherein the steps are performed sequentially.

20. A method of monitoring physical conditions of a bed occupant comprising:
detecting parameters dealing with a bed occupant's physical condition using sensors embedded in bedding;
monitoring said detected parameters to obtain specified parameter values at specified intervals based on said bed occupant's physical condition;
transmitting said specified parameter values to an alerting device; and
alerting a caregiver of said specified parameter values at said specified intervals using said alerting device.

21. The method of claim 20 wherein the steps are performed sequentially.

22. The method of claim 20 wherein the detected parameter is the bed occupant's temperature.

23. The method of claim 20 wherein the bedding is for a crib.

24. The method of claim 20 wherein the bedding is a mattress sheet.
